(19) United States
(12) Patent Application Publication
(10) Pub. No.: US 2015/0132520 A1
(43) Pub. Date: May 14, 2015

(54) FLAT PANEL DISPLAY APPARATUS

(71) Applicant: Samsung Display Co., Ltd., Yongin-City (KR)

(72) Inventors: Kyung-Woo Han, Yongin-City (KR); Jong-In Lee, Yongin-City (KR); Young-Kuil Joo, Yongin-City (KR)

(73) Assignee: SAMSUNG DISPLAY CO., LTD., Yongin-City (KR)

(21) Appl. No.: 14/208,361

(22) Filed: Mar. 13, 2014

(30) Foreign Application Priority Data
Nov. 8, 2013 (KR) 10-2013-0135849

(51) Int. Cl. G06F 1/16; B32B 37/12; B32B 37/16

(52) U.S. Cl. CPC G06F 1/1601; G06F 1/16; B32B 37/16; B32B 37/12
USPC 428/38; 156/60

(57) ABSTRACT

A flat panel display apparatus includes: a display panel which displays an image; a window facing the display panel, where a first surface of the window faces the display panel; and a black matrix on a second surface of the window opposite to the first surface of the window.

This application claims priority to Korean Patent Application No. 10-2013-0135849, filed on Nov. 8, 2013, and all the benefits accruing therefrom under 35 U.S.C. §119, the disclosure of which is incorporated herein in its entirety by reference.

### BACKGROUND

1. Field

One or more exemplary embodiment of the invention relates to a flat panel display apparatus.

2. Description of the Related Art

In general, a flat panel display apparatus such as an organic light-emitting display apparatus or a liquid crystal display (“LCD”) apparatus has a structure in which a window covers and protects a display panel on which an image is realized.

### SUMMARY

One or more exemplary embodiment of the invention includes a flat panel display apparatus having a display panel and a window.

According to one or more exemplary embodiments of the invention, a flat panel display apparatus includes a display panel which displays an image; a window facing the display panel, where a first surface of the window faces the display panel; and a black matrix on a second surface of the window opposite to the first surface of the window.

A hard coating layer may be further on the second surface of the window and overlap the black matrix.

An anti-fingerprint coating layer may be further on the hard coating layer, and a low-reflection coating layer may be further between the hard coating layer and the anti-fingerprint coating layer.

An adhesive film may be further interposed between the first surface of the window and the display panel.

The first surface of the window may be flat without a step difference.

A window member of the flat panel display apparatus may include the window, and a functional layer on the first surface of the window, and between the first surface of the window and the display panel. The functional layer may include a touch screen panel, a polarizing plate or a transparent conductive layer.

The window may include a material including plastic.

### BRIEF DESCRIPTION OF THE DRAWINGS

These and/or other features of this disclosure will become apparent and more readily appreciated from the following description of the exemplary embodiments, taken in conjunction with the accompanying drawings in which:

FIG. 1 is a cross-sectional view of an exemplary embodiment of a flat panel display apparatus according to the invention;

FIG. 2A is an enlarged view of portion A shown in FIG. 2;

FIG. 2B is an enlarged view of a comparative example in which a black matrix is disposed on a surface of a window facing a display panel;

FIG. 3 is a cross-sectional view of another exemplary embodiment of a flat panel display apparatus, according to the invention;

FIG. 4 is a cross-sectional view of still another exemplary embodiment of a flat panel display apparatus, according to the invention; and

FIG. 5 is a cross-sectional view of yet another exemplary embodiment of a flat panel display apparatus, according to the invention.

### DETAILED DESCRIPTION

Reference will now be made in detail to exemplary embodiments, examples of which are illustrated in the accompanying drawings. In this regard, the exemplary embodiments may have different forms and should not be construed as being limited to the descriptions set forth herein. Accordingly, the exemplary embodiments are merely described below, by referring to the figures, to explain features of the disclosure.

In the accompanying drawings, those components that are the same or are in correspondence are rendered the same reference numeral regardless of the figure number, and redundant explanations are omitted.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

In the drawings, for convenience of description, the thicknesses or sizes of elements are exaggerated for clarity, but one or more exemplary embodiments of the invention are not limited thereto.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Also, it should also be noted that in some alternative implementations, the steps of all methods described herein may occur out of the order. For example, two steps illustrated in succession may in fact be executed substantially concurrently or the two steps may sometimes be executed in the reverse order.

Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

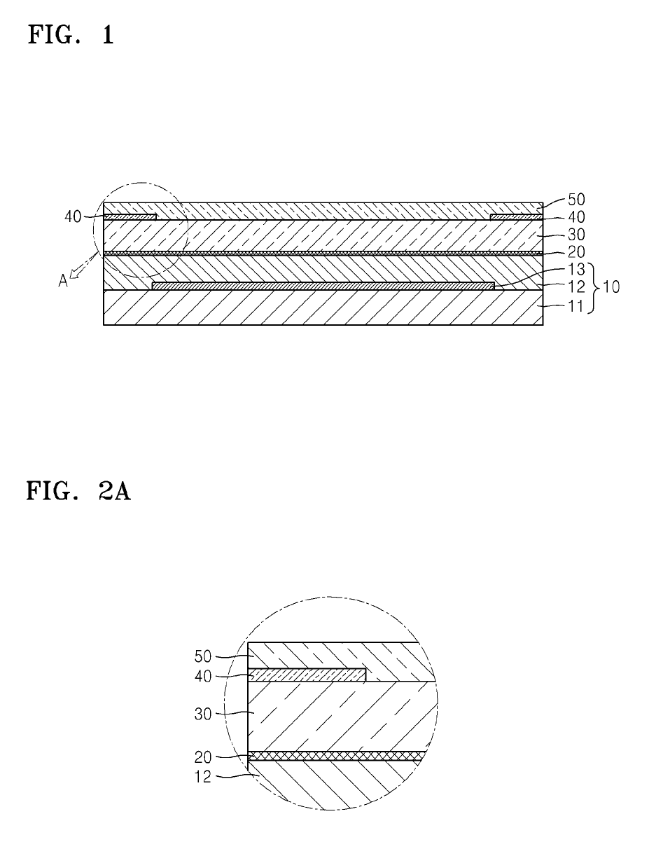

FIG. 1 is a cross-sectional view of an exemplary embodiment of a flat panel display apparatus according to the invention.

The flat panel display apparatus has a structure in which a display panel 10 and a window 30 are coupled to each other. An adhesive film 20 is interposed between the display panel 10 and the window 30 and couples the display panel 10 and the window 30 to each other. That is, a surface of the window 30 is adhered to the display panel 10 by using the adhesive film 20 as a medium.

The display panel 10 is an element for realizing an image, and has a structure in which a display unit 13 and an encapsulation member 12 for covering and protecting the display unit 13 are disposed on a substrate 11. The substrate 11 and the encapsulation member 12 may include a rigid material, or where the flat panel display apparatus is a flexible flat panel display apparatus, the substrate 11 and the encapsulation member 12 may include a flexible material.

The window 30 for covering and protecting the display panel 10 may include one of various plastic materials such as polyamide, polyurethane, silicone, polycarbonate, polyethylene terephthalate, polyaramid, polyimide, or the like.

A light-blocking member such as a black matrix 40 is disposed on the window 30 so as to reduce or effectively prevent an escape of light by blocking light at an outside area of the display unit 13 of the display panel 10.

In an exemplary embodiment of manufacturing the flat panel display apparatus, the black matrix 40 may be formed by printing color ink such as black ink on the window 30. The color ink may indicate a composition of a resin, solvents and/or additives. The resin may include acrylics, ketones, maleics, alkyds, cellulose derivatives, rubber resins, phenolics, formaldehydes, epoxides, fumarics, hydrocarbons, isocyanate free polyurethanes, polyamides, polyvinyl butyral, or the like, the solvents may include methylated spirits, ethyl acetate, isopropanol, n-propyl acetate, or the like, and the additives may include cyclohexanone, butoxyethanol, aromatic distillates, butyrolactone, methoxypropanol acetate, or the like.

As illustrated in FIG. 1, the black matrix 40 is disposed on a surface of the window 30 which is opposite to a surface of the window 30 which faces the display panel 10. When it is assumed that the surface of the window 30 that faces the display panel 10, i.e., a surface to which the adhesive film 20 is adhered, is referred as one or a first surface of the window 30, and an opposite surface of the window 30 is referred as the other or second surface of the window 30, the black matrix 40 is disposed on the other surface of the window 30, not on the one surface of the window 30. By disposing the black matrix 40 on the other surface of the window 30, the flat panel display apparatus has a structure that is effective for solving a problem such as an occurrence of air bubbles.

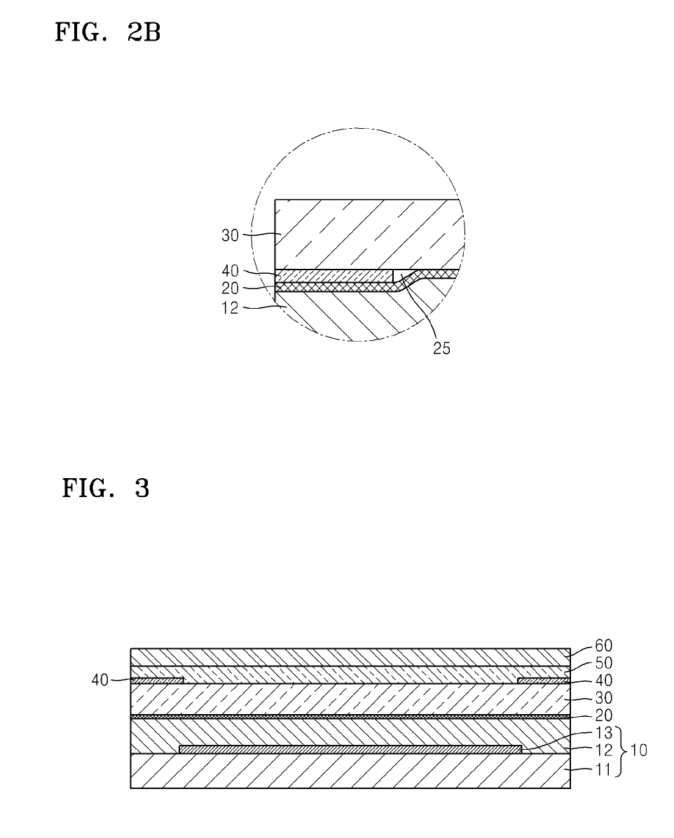

Comparing FIGS. 2A and 2B, the effect of the aforementioned disposition of the black matrix 40 can be clearly observed. FIG. 2A is an enlarged view of portion A of the structure shown in FIG. 2. FIG. 2B is an enlarged view of a comparative example in which the black matrix 40 is disposed on the one surface of the window 30 (e.g., a surface to which the adhesive film 20 is adhered).

Referring to FIG. 2A that illustrates in an exemplary embodiment of the invention, the display panel 10 and the window 30 are adhered to each other without being affected by the black matrix 40, so that the display panel 10 and the window 30 are completely adhered to each other without a gap therebetween. That is, a profile of the one surface of the window 30 is completely planar and does not have a projecting portion such as the black matrix 40 and therefore is flat without having a step difference defined by the projecting portion, so that the one surface of the window 30 may be completely adhered to the display panel 10 without the gap therebetween.

However, as in the comparative example of FIG. 2B, if the black matrix 40 is disposed on the one surface of the window 30, a step difference is defined in the profile of the one surface of the window 30 due to the black matrix 40 such that a gap 25 is defined when the one surface of the window 30 is adhered to the display panel 10 by having the adhesive film 20 interposed between the window 30 and the display panel 10. The gap 25 is also referred to as an air bubble, and a flat panel display apparatus having the air bubble defined within the structure thereof is classified as a defective product because a viewing screen of the flat panel display apparatus shows artifacts due to the bubbles within the structure thereof.

Thus, by forming the black matrix 40 on the other surface of the window 30, the one surface of the window 30 which faces the display panel 10 has a substantially flat profile, so that the occurrence of air bubbles may be reduced or effectively prevented.

A coating layer 50 is arranged on the other surface of the window 30 so as to remove a step difference between the display panel 10 and the window 30 and to improve durability of the flat panel display apparatus. The hard coating layer 50 may include a rigid or hard material, such as silsesquioxane, an acrylic-based material, a silane-based material, an epoxy-based material, a urethane-based material, a silicone-based material, or the like.

In one or more exemplary embodiment of the flat panel display apparatus according to the invention, the occurrence of air bubbles due to the step difference between the display panel 10 and the window 30 may be reduced or effectively prevented so that a defect rate of products may be decreased.

In addition, various structures that are obtained by modifying the structure of the previous exemplary embodiment are also available according to the invention.

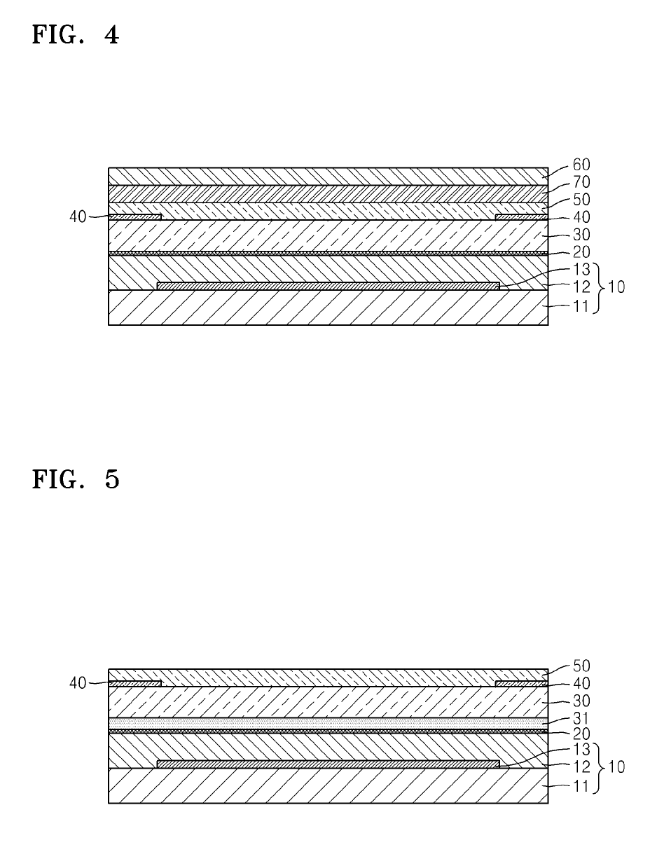

In an exemplary embodiment as illustrated in FIG. 3, an anti-fingerprint coating layer 60 may be further disposed on the coating layer 50, and in the exemplary embodiment as illustrated in FIG. 4, a low-reflection coating layer 70 for suppressing reflection of external light, and the anti-fingerprint coating layer 60 may be sequentially disposed on the hard coating layer 50.

Referring to FIG. 5, a collective window member may include a functional layer 31, and the window 30 for covering and protecting the functional layer 31 as well as the display panel 10. The window member and the display panel 10 are coupled to each other. An adhesive film 20 is interposed between the display panel 10 and the window member and couples the display panel 10 and the window member to each other. That is, a surface of the window member is adhered to the display panel 10 by using the adhesive film 20 as a medium.

The black matrix 40 is disposed on a surface of the window member which is opposite to a surface of the window member which faces the display panel 10. When it is assumed that the surface of the window member that faces the display panel 10, i.e., a surface to which the adhesive film 20 is adhered, is referred as one or a first surface of the window member, and an opposite surface of the window member is referred as the other or second surface of the window member, the black matrix 40 is disposed on the other surface of the window member, not on the one surface of the window member. By disposing the black matrix 40 on the other surface of the window member, the flat panel display apparatus has a structure that is effective for solving a problem such as an occurrence of air bubbles.

Since the one surface of the window member is flat as omitting the black matrix 40 thereon, as illustrated in FIG. 5, the functional layer 31 may define the one surface of the window member. That is, the functional layer 31 may be integrally formed with other features of the window member. The functional layer 31 may be directly on the one surface of the window 30 to be considered integrally formed therewith, but the invention is not limited thereto.

Referring to the comparative example of FIG. 2B, if the profile of the one surface of the window 30 is stepped due to the black matrix 40 disposed thereon, disposing or forming the functional layer 31 may be difficult. However, when the one surface of the window 30 is flat as in exemplary embodiments of the invention, disposing or forming the functional layer 31 may be achieved.

The functional layer 31 may include a coated polarizing plate, a transparent conductive layer and/or a touch screen panel. In an exemplary embodiment of manufacturing a flat panel display apparatus, the functional layer 31 or elements thereof are separately formed and then subsequently combined with the display panel 10 so as to be integrally formed on the one surface of the window 30. In one or more exemplary embodiment of the invention, when the aforementioned elements and/or the functional layer 31 are integrally formed on the one surface of the window 30, a final product structure of the flat panel display apparatus may be simple and slim.

It should be understood that the exemplary embodiments described herein should be considered in a descriptive sense only and not for purposes of limitation. Descriptions of features within each exemplary embodiment should typically be considered as available for other similar features in other exemplary embodiments.

While one or more exemplary embodiments of the invention has been described with reference to the figures, it will be understood by those of ordinary skill in the art that various changes in form and details may be made therein without departing from the spirit and scope of the invention as defined by the following claims.

What is claimed is:

1. A flat panel display apparatus comprising:
a display panel which displays an image;
a window facing the display panel, wherein a first surface of the window faces the display panel; and
a black matrix on a second surface of the window opposite to the first surface of the window.

2. The flat panel display apparatus of claim 1, further comprising a hard coating layer on the second surface of the window and overlapping the black matrix.

3. The flat panel display apparatus of claim 2, further comprising an anti-fingerprint coating layer on the hard coating layer.

4. The flat panel display apparatus of claim 3, further comprising a low-reflection coating layer between the hard coating layer and the anti-fingerprint coating layer.

5. The flat panel display apparatus of claim 1, further comprising an adhesive film between the first surface of the window and the display panel.

6. The flat panel display apparatus of claim 1, wherein the first surface of the window is flat and excludes a step difference.

7. The flat panel display apparatus of claim 6, wherein a window member of the flat panel display apparatus comprises:
the window, and
a functional layer on the first surface of the window, and between the first surface of the window and the display panel.

8. The flat panel display apparatus of claim 7, wherein the functional layer comprises a touch screen panel, a polarizing plate or a transparent conductive layer.

9. The flat panel display apparatus of claim 1, wherein the window comprises a material comprising plastic.

10. The flat panel display apparatus of claim 1, wherein the black matrix is disposed at edges of the window and defines a step difference at the second surface of the window.

11. The flat panel display apparatus of claim 10, further comprising a hard coating layer on the second surface of the window and planarizing the step difference at the second surface of the window.

12. The flat panel display apparatus of claim 1, further comprising an adhesive film between the first surface of the window and the display panel, wherein an entire of the first surface of the window contacts the adhesive film.

13. The flat panel display apparatus of claim 8, wherein an entire surface of the functional layer, facing the first surface of the window, contacts the first surface of the window.

14. The flat panel display apparatus of claim 13, further comprising an adhesive film between a surface of the functional layer, facing the display panel, and the display panel.

15. A method of manufacturing a flat panel display apparatus, comprising:
providing a display panel which displays an image;
disposing a first surface of a window member facing the display panel;
coupling the first surface of the window member to the display panel, and
disposing a black matrix on a second surface of the window member opposite to the first surface of the window member.

16. The method of claim 15, wherein the coupling the first surface of the window member to the display panel comprises adhering an entire of the first surface of the window member to the display panel, via an adhesive film.

17. The method of claim 15, wherein the window member comprises:
a window, and
a functional layer on the window and defining the first surface of the window member,
wherein
a surface of the window, facing the functional layer, is flat and excludes a step difference, and
the functional layer comprises a touch screen panel, a polarizing plate or a transparent conductive layer.
